(19) United States
(12) Patent Application Publication
(10) Pub. No.: US 2024/0211332 A1
(43) Pub. Date: Jun. 27, 2024

(54) TECHNIQUES TO SUSTAIN ERROR INFORMATION FOR CRASH DATA ERROR HARVESTING

(71) Applicant: Intel Corporation, Santa Clara, CA (US)

(72) Inventors: Divya GUPTA, Hillsboro, OR (US); Shubhada PUGAONKAR, Portland, OR (US); Raed AL-OMARI, Round Rock, TX (US); Mariecel TORRES-YOUNG, Portland, OR (US); Ayman G. ABDO, Lake Oswego, OR (US); John R. AYERS, Portland, OR (US); Chih-Cheh CHEN, Portland, OR (US); Wilfredo FIGUEROA MARTINEZ, Hillsboro, OR (US); Girish CHANDRASEKARAN, Hillsboro, OR (US)

(21) Appl. No.: 18/596,471

(22) Filed: Mar. 5, 2024

(51) Int. Cl. G06F 11/07

(52) U.S. Cl. CPC G06F 11/0772; G06F 11/0757; G06F 11/0778

(57) ABSTRACT

Examples include techniques to collecting and providing error related information for a multi-die system-on-a-chip (SOC) computing system following a critical or catastrophic error. Examples include circuitry on a first die that is configured to receive an indication of a critical or catastrophic error and cause error related information to be stored to a volatile memory at the first die that is arranged to continually maintain power during a global reset of the SOC. The circuitry can also be configured to provide the stored error related information to a requestor following the global reset of the SOC.

### TECHNICAL FIELD

Examples described herein are generally related error information associated with crash data error harvesting of a system-on-a-chip (SOC) or system-on-a-package (SOP).

### BACKGROUND

One or more SOCs or system-on-a-package (SOPs) included in a computing platform or system such as a server platform can include management agents to dump and then gather crash data from various hardware components or dies included in a respective SOC or SOP following a catastrophic error of one or more of the various hardware components. The various hardware components can include CPU core elements and CPU uncore elements resident on one or more dies or chips sometimes referred to as a core building blocks (CBBs). The various hardware components can also include one or more intellectual property (IP) blocks of companion dice coupled with the CBBs such as integrated memory hub or input/output (I/O) dies. The one or more IP blocks of the integrated memory hub or I/O dies can be coupled with the CBB on a same circuit board or package.

In some examples, management agents of an SOC or SOP can implement a type of crash data harvesting known as a crash dump following a catastrophic error of one or more of the various hardware components (e.g., a core at a CBB). A crash dump can include crash data harvesting where crash data is pulled from crash logs maintained at CBBs or integrated memory hub or I/O dies. These crash logs can indicate error or state information of the various hardware components when the catastrophic error was encountered. The error or state information can then be harvested and used to debug SOCs or SOPs of a computing platform to avoid subsequent catastrophic errors.

### BRIEF DESCRIPTION OF THE DRAWINGS

FIG. 1 illustrates an example first system.

FIG. 2 illustrate an example detailed portion of the system.

FIG. 3 illustrates an example process.

FIG. 4 illustrates an example signal sequence.

FIG. 5 illustrates an example Vnn power retained indication scheme.

FIG. 6 illustrates an example second system.

FIG. 7 illustrates an example logic flow.

FIG. 8 illustrates an example storage medium.

FIG. 9 illustrates an example block diagram for a computing platform.

### DETAILED DESCRIPTION

As contemplated in the present disclosure, crash data harvesting can include one or more management or crash agents of an SOC or an SOP in a computing platform pulling or obtaining crash data from crash logs following a catastrophic error of one or more hardware components of the SOC or SOP. For example, one or more cores at a CBB die can encounter a catastrophic error such as a three-strike timeout. A three-strike timeout catastrophic error encountered by the one or more cores at the CBB can be signaled via a type of signal such as a CATERR/IERR signal. Processor manufactures (e.g., Intel® Corporation), original equipment manufacturers (OEMs) and computing platform operators such as cloud service providers (CSPs) have constantly dealt with unreliable error harvesting once a fatal or catastrophic error is encountered in a computing platform system, due to an instability of the computing platform system before issuance of a hard reset that can be referred to as a global reset (GR).

In some examples, a GR can be needed to bring a computing platform system to a reliable, error harvestable state. Additionally, a persistent storage device such as a non-volatile memory device (e.g., non-volatile random access memory (NVRAM)) can be utilized to save harvested crash log error information. The non-volatile memory device, for example, can be located either on a same die as an agent harvesting error information from crash logs or can be externally located. Another option is for an SOC or SOP to support a type of warm reset called surprise warm reset that requires IP blocks at each die of the SOC or SOP to maintain sticky error registers to at least temporarily save crash log error information.

According to some examples, a platform controller hub (PCH) can be utilized to issue a GR when a fatal or catastrophic error is encountered. For these examples, a race to retrieve crash log error information before issuance of a GR was often deemed as undesirable by OEMs and CSPs. In order to buy more time to retrieve crash log error information, a solution named demoted warm reset/dirty warm reset (DWR) included issuance of a shallower reset to cause a reset to just a central processing unit (CPU) and/or processing cores of the CPU to obtain machine check architecture (MCA) and crash log error information from SOC or SOP management or crash agents post issuance of the shallower DWR reset. Error information possibly indicating what caused a GR were stored in a small external RAM or NVRAM that could be considered as too small to maintain an adequate amount of useful crash log error information. Lack of an IP block reset architecture and interdependencies between PCH components and the CPU and/or processing cores of the CPU can possibly result in an inconsistent computing platform system boot that may cause crash log error information to not be provided to a basic input/output system (BIOS) and thus result in loss of helpful crash log error information. Also, validating a flow for crash log error information harvesting can take several months due to complexity of the flow that is made even more complex due to several different participants in the flow (e.g., PCH, CPU/cores, micro code, IP blocks, BIOS, etc.). Also, establishing BIOS and out-of-band (OOB) capabilities to harvest crash log error information and then porting those over to an external non-volatile memory device can add additional months of design and computing platform system validation overhead.

In some examples, a computing platform system may not include a PCH. For these examples, techniques to harvest crash log error information can include issuance of a surprise warm reset (SWR) that can also be referred to as an asynchronous warm reset (AWR). An issuance of an AWR can reset more than just the CPU or processing cores of an SOC or SOP (e.g., maintained on a CBB die) and can reset management or crash agents on other dies. For example, a management or crash agent such as a secure startup service module (S3M) located on an integrated memory hub or I/O die that can act as a PCH. Crash log error information can be extracted after issuance of an SWR/AWR and before issuance of a GR that is issued to recover the computing platform system from a fatal or catastrophic error. Thus, operators/customers of CSPs for these computing platform systems can have some control to issue an SWR/AWR reset. However, even though issuance of an SWR/AWR reset can provide some control, operators/customers of CSPs may still need to retrieve/harvest crash log error information after the SWR/AWR reset and store the retrieved/harvested crash log error information to a non-volatile memory storage device that is often external to the SOC, SOP or computing platform system. Meanwhile, a computing platform system may need to delay GR so that retrieved/harvested crash log error information is not lost. Post fatal/catastrophic error, the computing platform system could be in a hung state, that even after a warm reset, all crash log error information might not be available to harvest/retrieve. Computing platform system downtime can unacceptably increase due to delaying GR in order to harvest/retrieve crash log error information following an SWR/AWR. Also, in some cases, not all IP blocks of an SOC or SOP may be capable of saving useful or critical crash log error information on sticky registers responsive to issuance of an SWR/AWR.

As described in this disclosure, in order to maintain crash log error information even after issuance of a global/hard reset (GR), techniques are described that include addition of static random access (SRAM) arrays at each die of an SOC or SOP that can be coupled with a power domain rail that remains on (e.g., does not toggle) following issuance of a GR. Management or crash log agents implemented at each die can be configured to save crash log error information to respective SRAMs before issuance of the GR and not re-initialize (wipe data) post issuance of the GR. As a result, external, non-volatile memory may not be needed to harvest/retrieve crash log error information as mentioned above in association with DWR and SWR/AWR techniques. Also, complexities associated with deploying sticky registers at all IP blocks to preserve crash log error information and corresponding delays are reduced when using on-die SRAMs that maintain crash log error information even after issuance of a GR.

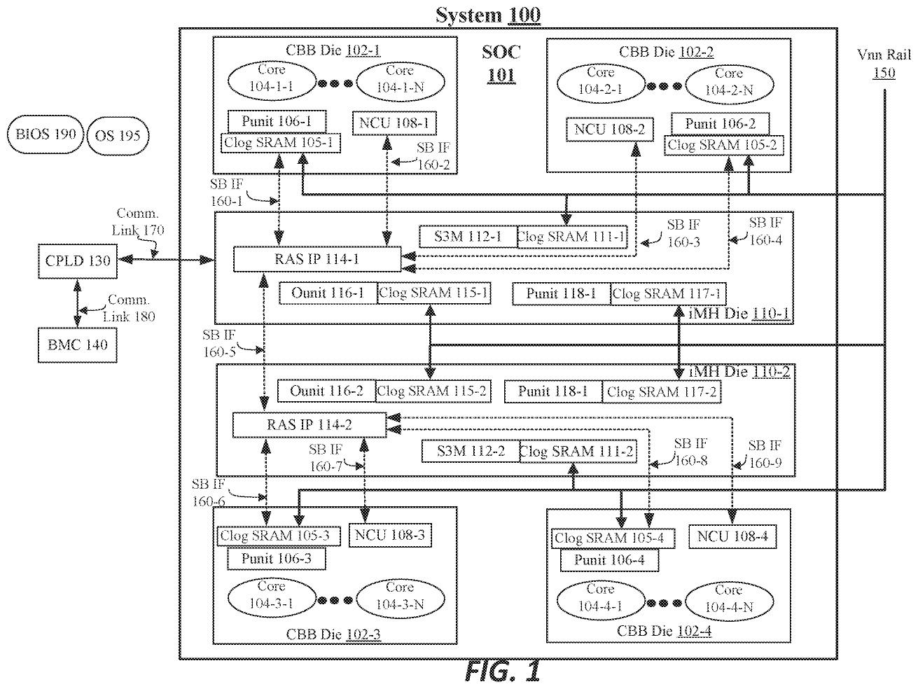

FIG. 1 illustrates an example system 100. System 100 may be at least a portion of, for example, a server computer, a desktop computer, or a laptop computer. In some examples, as shown in FIG. 1, system 100 includes a basic I/O system (BIOS) 190 and an operating system (OS) 195. BIOS 190, for example, can be arranged as a Unified Extensible Firmware Interface (UEFI) BIOS. Also, as shown in FIG. 1, a portion of system 100 can include a plurality of disaggregated dies included in an SOC 101. The plurality of disaggregated dies can include, for example, CBB dies 102-1 to 102-4 and integrated memory hub (iMH) dies 110-1 to 110-2. Examples are not limited to 4 CBB dies and 2 iMH dies, any number of CBB dies and/or iMH dies are contemplated to be included in an SOC such as SOC 101. Also, examples are not limited to only CBB dies and iMH dies, other types of dies can include, but are not limited to, memory device dies, accelerator dies, graphic processing unit (GPU) dies, field programmable gate array (FPGA) dies, or application specific integrated circuit (ASIC) dies.

According to some examples, as shown in FIG. 1, system 100 also includes a complex programmable device (CPLD 130), a baseboard management controller (BMC) 140 and a Vnn Rail 150. As described in more detail below, CPLD 130 and BMC 140 can be configured to facilitate collection of crash log error information following indication of a critical or catastrophic error by one or more components of CBB dies 102 or iMH dies 110. Meanwhile, Vnn rail 150 can be configured to provide an always on power capability to maintain power to various crash log (Clog) SRAMs located on CBB dies 102 and iMH dies 110 to enable CPLD 130 and/or BMC 140 to harvest/retrieve crash log error information post issuance of a global reset (GR). Although not shown in FIG. 1, Vnn rail 150 can be part of a voltage regulation (VR) network maintained on a compute platform system's motherboard.

In some examples, as shown in FIG. 1, CBB dies 102 each include one or more cores 104. For example, CBB die 102-1 can include cores 104-1-1 to 104-N, where “N” represents any positive, whole integer greater than 1. Cores 104, for example, can be processing cores for executing instructions associated with processing workloads by SOC 101. In some examples, SOC 101 can be configured as a processor or CPU and cores 104 can be configured as execution units of the processor or CPU. SOC 101 configured as a processor or CPU, for example, can be a commercially available processor or CPU such as, but not limited to, a processor or CPUs designed by and/or manufactured by Intel®, AMD®, Samsung®, Qualcomm® or ARM®.

According to some examples, as shown in FIG. 1, CBB dies 102 each include a Punit 106. Punits 106 can be a type of crash agent based on executable code or firmware executed by circuitry separately maintained at or on respective CBB dies 102. The circuitry could be a core from among cores 104 or could be a separate FPGA, a separate ASIC, or portion of a separate FPGA or ASIC maintained on CBB die 102. In some examples, Punits 106 can couple with or have access to respective Clog SRAMs 105. Clog SRAMs 105 can be a type of volatile memory maintained at or on a CBB dies 102 that, as shown in FIG. 1, can couple with respective power traces of Vnn rail 150. As described more below, Punits 106 at each CBB die 102 can be configured as crash log agents to write data to a curated crash log that includes error information associated with a critical or catastrophic error that may have occurred at one or more components of SOC 101 that can include, but is not limited to, a catastrophic error at one or more cores 104.

According to some examples, as shown in FIG. 1, each CBB die 102 can also include respective non-coherent units (NCUs) 108. For these examples, NCUs 108 can represent non-coherent units separate from cores 104 that can include one or more IP blocks (not shown). For example, for use in data error correction or other types of operations at a CBB die that may not require data or memory coherency.

According to some examples, iMH dies 110-1 and 110-2 can be configured to serve as a type of intermediate I/O die when SOC 101 is configured to operate as a processor or CPU. For these examples, iMH dies 110-1 to 110-2 can facilitate input and output of data to/from or between CBB dies 102. For example, from/to memory dies, accelerator dies, GPU dies or other types of dies that can be included in SOC 101 (not shown) or external to SOC 101 (also not shown). In some examples, as shown in FIG. 1, iMH dies 110-1 and 110-2 each include a secure startup service module (S3M) 112, a reliability, availability and serviceability (RAS) IP 114, an out-of-bound manageability service module (OOBMSM) unit (Ounit), and a Punit 118. For these examples, similar to Punits 106 at CBB dies 102, S3M 112, Ounit 116 and Punit 118 at iMH dies 110 can be a type of management or crash agent based on executable code or firmware. The executable code or firmware, for example, can be executed by circuitry separately maintained at or on respective iMH dies 110 (not shown). The circuitry separately maintained at or on the respective iMH dies 110 can be separate FPGAs or separate ASICs for each management or crash agent or can be portions of one or more FPGAs or ASICs, each portion including circuitry to support one or more management or crash agents. Also for these examples, as shown in FIG. 1, S3M 112, Ounit 116 and Punit 118 can couple with or have access to respective Clog SRAMs 111, 115 and 117. Clog SRAMs 111, 115 and 117, in some examples, can be located at or on or an iMH die 110. Similar to what was mentioned above for Clog SRAMs 105, Clog SRAMs 111, 115 and 117 can couple with respective power traces of Vnn rail 150.

According to some examples, as described more below, RAS IP 114 can be an IP block maintained at or on iMH dies 110-1/2 that can be configured to receive indications of a critical or catastrophic error from other components of SOC 101 via any one of sideband interfaces (SB Ifs) 160-1 to 160-9. For example, NCU 108-1 at CBB die 102-1 can send a machine check architecture (MCA) related error via SB IF 160-2 to RAS IP 114-1 at iMH die 110-1 or Punit 106-1 can be configured to indicate a critical or catastrophic error (IERR) associated with a hung or stall by one or more of cores 104-1-1 to 104-1-N. For this example, RAS IP 114-1 can be configured to cause S3M 112-1, Ounit 116-1 and Punit 118-1 to write data to respective curated crash logs that include error information associated with the catastrophic or MCA related error indication(s) received by RAS IP 114-1. SB IFs 160-1 to 160-9, for example, can be configured as two-wire, two-way chip-to-chip or die-to-die (D2D) communication paths that can be configured to operate in compliance with one or more industry specifications such as, but not limited to, an industry specification developed by the Mobile Industry Processor Interface (MIPI) Alliance Sensor Working Group known as the MIPI I3C specification, version 1.1.1, published in June 2021 (“the I3C specification”).

In some examples, iMH die 110-1 serves as a primary iMH die for SOC 101. For these examples, RAS IP 114-1 at iMH die 110-1 can communicatively couple with CPLD 130 and BMC 140 via communication link 170. Also, BMC 140 can communicatively couple with CPLD 130 via communication link 180 and BMC 140 can then communicate with elements of iMH die 110-1 through CPLD 130. In alternative examples, BMC 140 may communicatively couple via a separate communication link (not shown). Also, BIOS 190 and/or OS 195 can be configured to obtain at lease some error information harvested or obtained from crash logs maintained in the various Clog SRAMs at CBB dies 102 or iMH dies 110 of SOC 101 through CPLD 130 and/or BMC 140. In some examples, communication links 170 and 180 can also be configured to operate as I3C communication links.

Although FIG. 1 indicates SRAM as a type of non-volatile memory included in a Clog SRAM. Other types of non-volatile memory such as, but not limited to, dynamic random access memory could be included in at least one of the Clog SRAMs located at or on CBB dies 102 or iMH dies 110.

According to some examples, SOC (e.g., SOC 101) can be a term often used to describe a device or system having compute elements and associated circuitry integrated monolithically into a single integrated circuit (“IC”) die, or chip. For example, a device, computing platform or computing system could have one or more compute elements and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SOP).

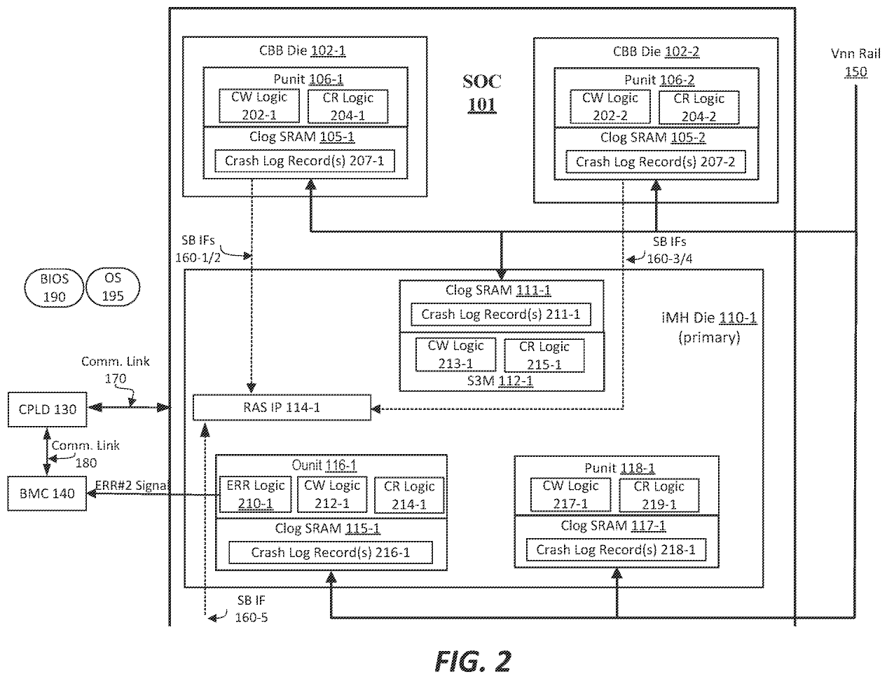

FIG. 2 illustrates an example detailed portion of system 100. In some examples, as shown in FIG. 2, the detailed portion of system includes an upper portion of SOC 101 that includes CBB dies 102-1/2 and iMH die 110-1 and also includes BIOS 190, OS 195, CPLD 130 and BMC 140.

According to some examples, as shown in FIG. 2, additional details are shown in relation to Punits 106-1/2 and Clog SRAMs 105-1/2 on CBB dies 102-1/2 and in relation to S3M 112-1, Ounit 116-1 and Punit 118-1 on iMH die 110-1. For these examples, Punit 106-1 and Punit 106-2 can include respective crash log write (CW) logic 202-1 and 202-2 that can be configured to write one or more respective crash log record(s) 207-1 and 207-2 to respective Clog SRAMs 105-1 and 105-2. Also, for these examples, S3M 112-1, Ounit 116-1 and Punit 118-1 can include respective CW logic 213-1, 212-1 and 217-1 that can be configured to write one or more respective crash log record(s) 211-1, 216-1 and 218-1 to respective Clog SRAMs 111-1, 116-1 and 117-1. Also, for these examples, Punit 106-1 and Punit 106-2 can include respective crash log read (CR) logic 204-1 and 204-2 that can be configured to read one or more respective crash log record(s) 207-1 and 207-2 from respective Clog SRAMs 105-1 and 105-2. Also, for these examples, S3M 112-1, Ounit 116-1 and Punit 118-1 can include respective CR logic 215-1, 214-1 and 219-1 that can be configured to read one or more respective crash log record(s) 211-1, 216-1 and 218-1 from respective Clog SRAMs 111-1, 116-1 and 117-1. The one or more crash log records written to the various Clog SRAMs can include error related information that can be used to determine what caused or triggered an error condition that led to a critical or catastrophic error. Each crash log record can contain a header section and a data section. The header section can contain relevant information such as completion status indicating success of data collection, record size, version, timestamp, or a trigger reason that can be used to qualify and interpret data content in the data section. The error condition, for example, can be associated with fatal and non-fatal uncorrectable errors including, but not limited to, completion timeouts (CTOs) or malformed transaction layer packets (TLPs) that can trigger, for example, a subsequent three-strike timeout.

In some examples, the additional details of the portion of SOC 101 shown in FIG. 2 as related to Ounit 116-1 show that Ounit 116-1 includes an error (ERR) logic 210-1. For these examples, ERR logic 210-1 can be configured to cause an ERR #2 signal to be asserted in response to RAS IP 114-1 providing an indication that a critical or catastrophic error has been encountered by, for example, one or more cores or NCUs on CBB dies 102-1/2. The indication of a critical or catastrophic error being encountered can be sent via SB IFs 160-1/2 or 160-3/4 to RAS IP 114-1. Also, although not shown in FIG. 2, RAS IP 114-2 on iMH die 110-2 could also receive an indication that a critical or catastrophic error has been encountered by, for example, cores or NCUs on CBB dies 102-3/4 sent via SB IFs 160-6/7 or 160-8/9 to RAS 114-2. RAS 114-2 can then forward this indication to RAS 114-1 on iMH die 110-1. RAS IP 114-1 can then cause a CATERR signal to be sent to Ounit 116-1 to provide the indication of the critical or catastrophic error and also provide a CATERR signal to CPLD 130 via communication link 170 to also indicate to CPLD 130 that a critical or catastrophic error has been encountered. The assertion of the ERR #2 signal by ERR logic 210-1 can be routed, for example, via communication link 170 and can cause CPLD 130 or BMC 140 to delay issuance of a GR until the ERR #2 signal is de-asserted. Thus, the ERR #2 signal can be asserted by ERR logic 210-1 for a period of time that allows CW logic 212-1 of Punits 106-1/2 on CBB dies 102-1/2 to gather and write error related information to crash log records 207-1/2 and CW logic 213-1, 212-1 and 217-1 of respective S3M 112-1, Ounit 116-1 and Punit 118-1 on iMH 110-1 die to gather and write error related information to respective crash log records 211-1, 216-1 and 218-1. Also, assertion of the ERR #2 signal by ERR logic 210-1 can allow CW logic of Punits 106-3/4 on CBB dies 102-3/4 and of S3M 112-2, Ounit 116-2 and Punit 118-2 on iMH 110-2 to write error related information to their respective crash log records (not shown in FIG. 2).

According to some examples and as described more below, after a period of time that allows for gathering and writing of error related information to the crash log records maintained in the Clog SRAMs at the various dies of SOC 101, the ERR #2 signal can be de-asserted by ERR logic 210-1 of Ounit 116-1. De-assertion of the ERR #2 signal can cause or trigger CPLD 130 or BMC 140 to issue a GR to SOC 101 to cause components at CBB dies 102 and iMH dies 110 to reset (e.g., are power cycled off/on), with the exception of the Clog SRAMs that will not power cycle and will maintain power via the power traces included in Vnn rail 150 during the GR. For these examples, CR logic 202-1/2 of Punit 106-1/2 on CBB dies 102-1/2 and CR logic 215-1, 214-1 and 219-1 of respective S3M 112-1, Ounit 116-1 and Punit 118-1 on iMH 110-1 die can read error related information from respective crash log records 211-1, 216-1 and 218-1 following an exit to or completion of the GR. Also, following the exit or completion of the GR, CW logic of Punits 106-3/4 on CBB dies 102-3/4 and of S3M 112-2, Ounit 116-2 and Punit 118-2 on iMH 110-2 can read error related information from their respective crash log records (not shown in FIG. 2). The error related information read from the respective crash log records maintained at the Clog SRAMs maintained at the various dies of SOC 101 can be passed to or obtained by BIOS 190 and/or OS 195 for possible use in mitigation or error correction actions to prevent or minimize a likelihood of subsequent critical or catastrophic errors encountered by SOC 101.

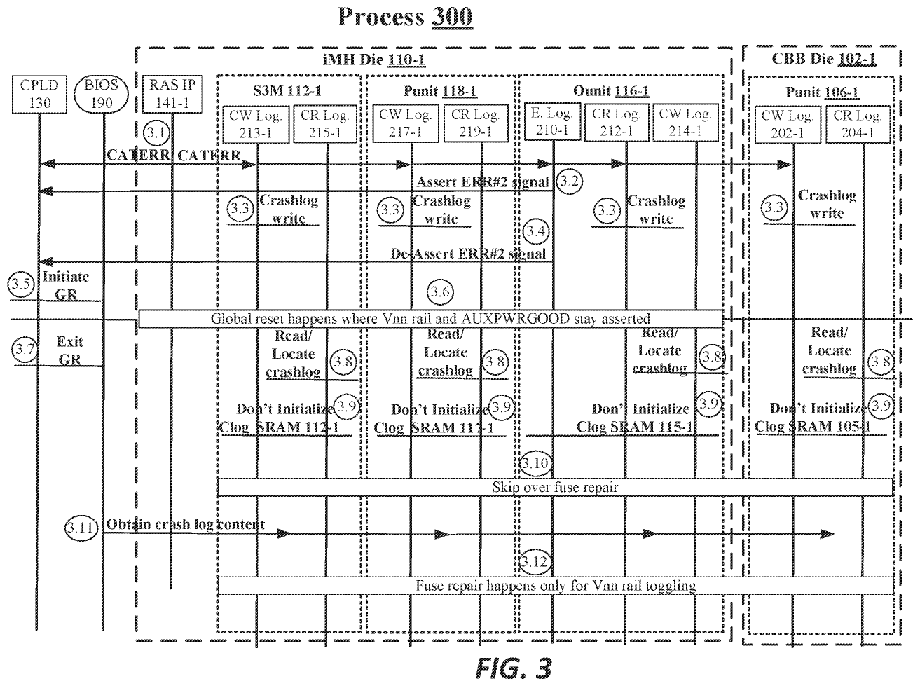

FIG. 3 illustrates an example process 300. In some examples, process 300 may be an example process of how logic and/or features of management or crash agents can facilitate gathering and reading of error related information associated with a critical or catastrophic error encountered by one or more components of the SOC. The management or crash agents, for example, can be based on executable code or firmware executed by circuitry separately maintained at or on various dies of an SOC such as SOC 101. Elements or hardware components of system 100 as shown in FIGS. 1 and 2 may be related to process 300. These elements or hardware components of system 100 may include, but are not limited to, CPLD 130, BIOS 190, iMH die 110-1 and CBB die 102-1. Also, process 300 can be related to management or crash agents and associated logic and/or features at or on iMH die 110-1 and CBB die 102-1 such as, but not limited to, CW/CR logic 213-1/215-1, 217-1/219-1, 212-1/214-1 of S3M 112-1, Punit 118-1 or Ounit 116 on iMH die 110-1 or CW/CR logic 202-1/204-1 of Punit 106-1 on CBB die 102-1. Additional logic and/or features of Ounit 116-1 such as, but not limited to, ERR logic 210-1 can also be related to process 300. In order to simplify the description of process 300, only a portion of SOC 101 that includes iMH die 110-1 and CBB die 102-1 is described in relation to gathering and reading of error related information associated with a critical or catastrophic error encountered by one or more components of SOC 101. Similar actions can occur for management or crash agents on other dies of SOC 101 such as CBB dies 102-2,3,4 and iMH die 110-2.

Beginning at process 3.1, logic and/or features of RAS IP 141-1, responsive to receipt of an indication of a critical or catastrophic error from components of SOC 101, can issue or provide a CATERR signal to CPLD 130 and crash agents at iMH die 110-1 and CB die 102-1. In some examples, as shown in FIG. 3, the CATERR signal can be provided to S3M 112-1, Punit 118-1 and Ounit 116-1 at iMH die 110-1 and provided to Punit 106-1 at CBB die 102-1.

Moving to process 3.2, the logic and/or features of Ounit 116-1, responsive to receipt of the CATERR signal, can cause an ERR #2 signal to be asserted and the asserted ERR #2 can be directed to or detected by CPLD 130. According to some examples, the logic and/or features of Ounit 116-1 configured to assert or cause the ERR #2 signal to be asserted can be ERR logic 210-1.

Moving to process 3.3, logic and/or features of S3M 112-1, Punit 118-1 and Ounit 116-1 at iMH die 110-1 and Punit 106-1 at CBB die 102-1 such as respective CW logic 213-1, 217-1, 212-1 and 202-1 can cause error related information to be written to crash log records maintained at Clog SRAMs maintained at iMH 110-1 and CBB die 102-1. In some examples, the Clog SRAMs can include Clog SRAM 105-1 at CBB die 102-1 or Clog SRAMs 111-1, 114-1 and 117-1 at iMH die 110-1.

Moving to process 3.4, logic and/or features of Ounit 116-11 such as ERR logic 210-1 can cause the ERR #2 signal to be de-asserted. According to some examples, de-assertion of the ERR #2 signal can serve as an indication to CPLD 130 that error related information associated with the critical or catastrophic error has been written to crash log records that are stored in Clog SRAMs.

Moving to process 3.5, logic and/or features of CPLD 130 can cause a global reset (GR) to be initiated or issued. In some examples, the GR can cause a power toggle of all power rails providing power to the computing platform that includes SOC 101 and/or to just SOC 101 with the exception of Vnn power rail 150.

Moving to process 3.6, the GR is initiated and Vnn power rail 150 continues to assert or provide a steady, uninterrupted source of power to the Clog SRAMs maintained at iMH die 110-1 and CBB die 102-1. Also, an AUXPWRGOOD signal can also be asserted to indicate that Vnn power rail 150 is providing the steady, uninterrupted source of power during the GR.

Moving to process 3.7, the GR is exited.

Moving to process 3.8, logic and/or features of S3M 112-1, Punit 118-1 and Ounit 116-1 at iMH die 110-1 or of Punit 106-1 at CBB die 102-1 can read or locate one or more crash log records(s) that include error related information associated with the critical or catastrophic error that can help to determine what caused the critical or catastrophic error. According to some examples, the logic and/or features of S3M 112-1, Punit 118-1, Ounit 116-1, and Punit 106-1 can include respective CR logic 215-1, 219-1, 214-1 and 204-1.

Moving to process 3.9, logic and/or features of S3M 112-1, Punit 118-1 and Ounit 116-1 at iMH die 110-1 or of Punit 106-1 at CBB die 102-1 can prevent respective Clog SRAMs 111-1, 117-1, 115-1 and 105-1 to not be initialized. In some examples, not initializing the Clog SRAMs can be based on the one or more crash log records that were read or located in the Clog SRAMs having information associated with the critical or catastrophic error. Not initializing the Clog SRAMs (e.g., erasing/wiping stored data) can serve as an indication that error related information has been gathered and written to these Clog SRAMs and as mentioned more below, can later be harvested for error mitigation or error avoidance purposes.

Moving to process 3.10, since the logic and/or features of S3M 112-1, Punit 118-1 and Ounit 116-1 at iMH die 110-1 or of Punit 106-1 at CBB die 102-1 have prevented respective Clog SRAMs 111-1, 117-1, 115-1 and 105-1 from not being initialized, a fuse repair is skipped over for these Clog SRAMs. Thus, crash log record information is maintained in these Clog SRAMs.

Moving to process 3.11, BIOS 190 can be configured to access Clog SRAMs 111-1, 117-1, 115-1 and 105-1 to harvest or collect error related information included in crash log records. According to some examples, BIOS 190 can use the collected error related information to mitigate or prevent subsequent critical or catastrophic errors and/or can provide the information to OS 195 for additional error mitigation or error avoidance actions.

Moving to process 3.12, a fuse repair happens only for Vnn rail toggling. In some examples, the fuse repair causes the one or more crash log records separately maintained in Clog SRAMs 111-1, 117-1, 115-1 and 105-1 to be erased or wiped. Process 300 can then come to an end.

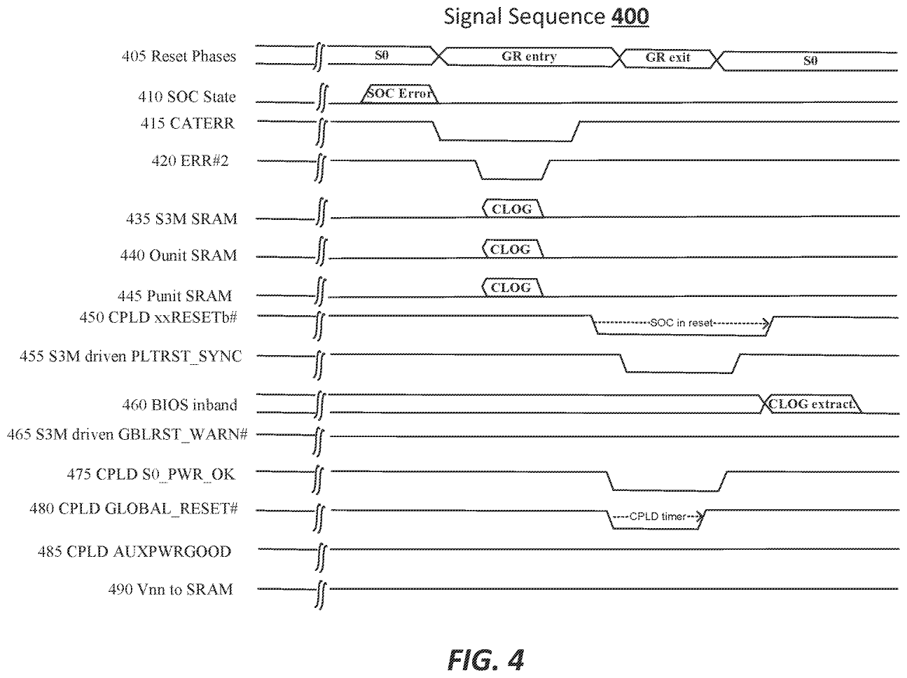

FIG. 4 illustrates an example signal sequence 400. According to some examples, signal sequence 400, as shown in FIG. 4 includes an example of signal sequences associated with a critical or catastrophic error encountered by an SOC such as SOC 101 that is initially in an S0 working state of operation and processes through a series of actions during signal sequence 400 that can coincide with, but is not meant to match what was described above for process 300 and shown in FIG. 3.

In some examples, 405 Reset Phases indicates that the SOC is initially in a S0 working or run state. S0, for example, can be based on the Advanced Configuration and Power Interface (ACPI) specification, Version 6.4, published by the UEFI Forum in January 2021, and/or subsequent or previous versions of the ACPI specification. 410 SOC State signal then indicates that an SOC error has occurred. For example, a critical or catastrophic event has occurred in SOC 101 and a RAS IP 141-1 receives an indication of the error via the 410 SOC State signal. RAS IP 141-1 can then cause 415 CATERR signal to be asserted to indicate to CPLD 130 and the crash agents on SOC 101 (e.g., S3Ms 112-1/2, Punits 118-1/2, Ounits 116-1/2 or Punits 106-1-4) that a critical or catastrophic event has occurred on SOC 101. Responsive to 415 CATERR signal being asserted, 405 Reset Phases moves to GR entry and Ounit 116-1 causes the 420 ERR #2 signal to be asserted. The assertion of 420 ERR #2 coincides with 435 S3M SRAM, 440 Ounit SRAM and 445 Punit SRAM to indicate that crash log records are being written to Clog SRAMs by logic and/or features of S3Ms 112-1/2, Punits 118-1/2, Ounits 116-1/2 or Punits 106-1-4. De-assertion of 420 ERR #2 coincides with completion of the logic and/or features of these crash agents writing crash log records to respective Clog SRAMs. Shortly after de-assertion of 420 ERR #2, 450 CPLD xxRESETb # is de-asserted and this de-assertion leads to de-assertion of 415 CATERR as well. However, 490 Vnn to SRAM indicates that Vnn rail 150 does not toggle when the rest of the power rails of SOC 101 are toggled, this toggling of the rest of the power rails to coincided with CPLD 130 asserting 780 CPLD GLOBAL_RESET #. Also, 465 S3M driven GLBLRST WARN # can indicate a warning to the logic and/or features of S3Ms 112-1/2, Punits 118-1/2, Ounits 116-1/2 or Punits 106-1-4 to prepare to read crash log records responsive to a reset of SOC 101 by CPLD 130 and 455 S3M driven PLTRST_SYNC can indicate to the logic and/or features of S3Ms 112-1/2, Punits 118-1/2, Ounits 116-1/2 or Punits 106-1-4 to coordinate or synchronize reading of crash log records following the reset of SOC 101. During GR exit, CPLD 130 keeps 485 CPLD AUXPWRGOOD asserted, asserts 480 CPLD GLOBAL_REST # then asserts 475 CPLD S0_POWER_OK and 450 CPLD xxRESETb # to enter a S0 state successfully as shown in the last phase of 405 Reset Phases. 460 BIOS inband coincides with BIOS 190 harvesting or obtaining error related information included in the crash log records read by the logic and/or features of S3Ms 112-1/2, Punits 118-1/2, Ounits 116-1/2 or Punits 106-1-4 from the various Clog SRAMs.

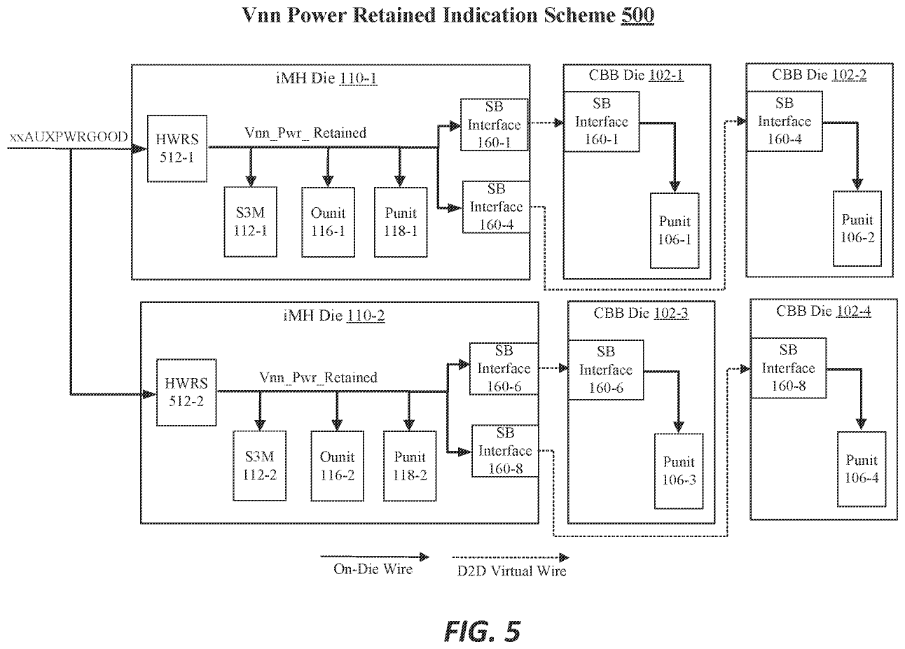

FIG. 5 illustrates an example Vnn power retained indication scheme 500. In some examples, Vnn power retained indication scheme 500 can represent SOC 101 coordination of Vnn power retained via Vnn rail 150 post a GR to ensure crash agents at the various dies of SOC 101 are made aware of an earlier (pre-GR) critical or catastrophic event that will lead to issuance of a GR and that crash log records have been captured and written to Clog SRAMs. The crash agents, as shown in FIG. 5, can include S3Ms 112-1/2, Ounits 116-1/2, Punits 118-1/2 at iMH dies 110-1/2 and can include Punits 106-1 to 106-4 at CBB dies 102-1 to 102-4. For these examples, a hardware reset sequencer (HWRS) 512-1 at iMH die 110-1 and an HWRS 5121-2 at iMH die 110-2 can be circuitry configured to generate a Vnn Power Retained indication to the crash agents at iMH dies 110-1 and 110-2 and at CBB dies 120-1 to 102-4. In some examples, “Vnn-Pwr_Retained”—0 (default) can indicate that whenever xxAUXPWRGOOD=0 state and will be set to a “1” state after all Clog SRAMs are initialized to zero's to indicate no possible crash log content. If “Vnn_Pwr_Retained=1, the Clog SRAMs can contain information written from a previous error event and thus no Clog SRAM initialization.

According to some examples, the “Vnn_Pwr_Retained” indication can be propagated to crash agents at iMH die 110-1 or iMH die 110-2 via respective on-die wires. The “Vnn_Pwr_Retained” indication can also be propagated from iMH die 110-1 through die-to-die (D2D) sideband (SB) interfaces 160-1 and 160-4 utilizing D2D virtual wires to reach respective SB interfaces 160-1 and 160-4 at CBB dies 102-1 and 102-2 that can be configured to relay or forward the “Vnn_Pwr_Retained” indication to respective Punits 106-1 and 106-2. The “Vnn_Pwr_Retained” indication can also be propagated from iMH die 110-2 through SB interfaces 160-6 and 160-8 utilizing D2D virtual wires to reach respective SB interfaces 160-6 and 160-8 at CBB dies 102-3 and 102-4 that can be configured to relay or forward the “Vnn_Pwr_Retained” indication to respective Punits 106-3 and 106-4.

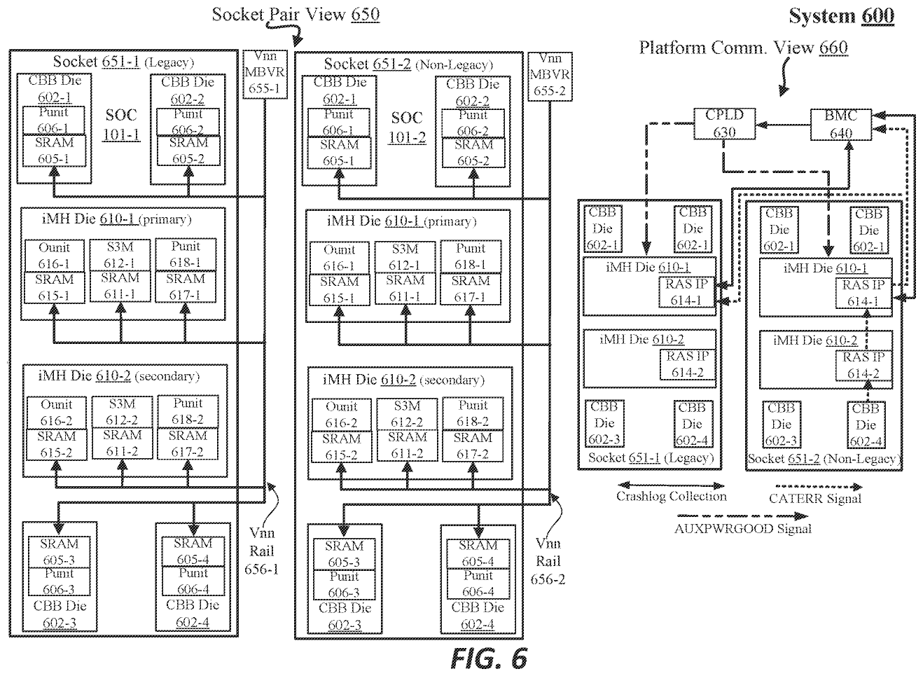

FIG. 6 illustrates an example system 600. According to some examples, system 600 is depicted in FIG. 6 in a socket pair view 650 and a platform communication view 660. For these examples, socket pair view 650 shows and example of a two sockets 651-1 and 651-2. Socket 651-1 can be configured to house or couple with a first SOC 601-1 and socket 651-2 can be configured to house or couple with a second SOC 601-2. This socket pair can be part of a computing platform system (e.g., a server) and SOCs 601-1 and 601-2 can be similar to SOC 101 mentioned above and shown in FIGS. 1-2. For example, SOCs 601-1 and 601-2 can include crash agents at iMH dies 610-1/2 that are shown in FIG. 6 as Ounits 616-1/2, S3Ms 612-1/2 and Punits 618-1/2 that couple with respective SRAMs 615-1/2, 611-1/2 and 617-1/2. SOCs 601-1 and 601-2 can also include crash agents at CBB dies 602-1 to 602-4 that are shown in FIG. 6 as Punits 605-1 to 605-4 that couple with respective SRAMs 605-1 to 605-4. In some examples, as shown in FIG. 6, SRAMS at iMH dies 610-1/2 and CBB dies 602-1 to 602-4 of SOC 601-1 can couple with power traces of a Vnn rail 656-1 originating from a Vnn motherboard voltage regulator (MBVR) 655-1. Also, as shown in FIG. 6, SRAMS at iMH dies 610-1/2 and CBB dies 602-1 to 602-4 of SOC 601-2 can couple with power traces of a Vnn rail 656-2 originating from a Vnn MBVR 655-2.

According to some examples, socket 651-1 can be configured as a legacy or boot socket and socket 651-2 can configured as a non-legacy or second to boot socket of a computing platform system. Also, SOCs 601-1/2 can each include a primary iMH die and a secondary iMH die. For example, iMH die 610-1 can be configured as the primary iMH die and iMH die 610-2 can be configured as the secondary iMH die.

In some examples, if non-legacy socket 651-2 encounters a critical or catastrophic error at CBB die 602-4 a CATERR signal that originates from CBB dies 602-4 can be propagated first to RAS IP 614-2 at iMH die 610-2 as shown in FIG. 6 for platform communication view 660. Since RAS IP 614-2 is at a secondary iMH die, RAS IP 614-2 propagates the CATERR signal to RAS IP 614-1 at the primary iMH die of iMH die 610-1. RAS IP 614-1 also sends a CATERR signal to BMC 640 to indicate that a critical or catastrophic error has been encountered. As a result of the CATERR signal being propagated to RAS IPs 614-1/2 at iMH dies 810-1/2, logic and/or features of all crash agents of SOC 601-1 at socket 651-1 and SOC 601-2 at socket 651-2 write crash log records to their respective SRAMs. Once crash log records have been written (e.g., ERR #2 signal de-asserted), sockets 651-1 and 651-2 go through a global reset (GR) and do not toggle the power provided to the respective SRAMs via Vnn MBVRs 655-1/2 through Vnn rails 656-1/2. Later, following exit of GR, BMC 640 and/or a BIOS (not shown) can collect crash log information that was maintained by the crash agents of SOC 601-1 at socket 651-1 and SOC 601-2 at socket 651-2. In some examples, CPLD 630 can provide an AUXPWRGOOD signal to iMH dies 610-1 at sockets 651-1 and 651-2. The AUXPWRGOOG signal can cause a “Vnn_Pwr_Retained” indication to be propagated to the various crash agents at iMH dies 610-1/2 and CBB dies 602-1 to 602-4 in similar manner as mentioned above and shown in FIG. 5.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

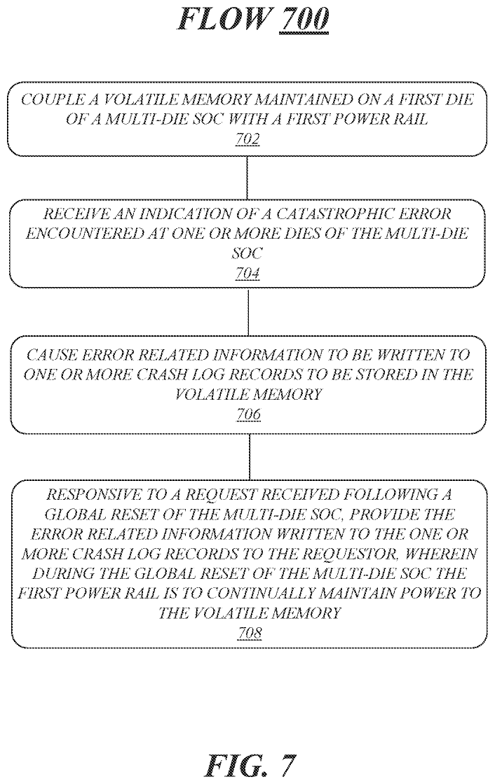

FIG. 7 illustrates an example logic flow 700. Logic flow 700 may be representative of some or all of the operations executed by one or more logic and/or features of management or crash agents executable by circuitry maintained at a multi-die SOC such as SOC 101 or SOC 601. For example, logic flow 700 can be implemented by logic and/or features supported by circuitry at one or more first dies of the multi-die SOC, the logic and/or features can include, but are not limited to, logic and/or features of RAS IP 114/6114, S3M 112/612, Ounit 116/616 or Punit 118/618 at iMH die 110/610 or logic and/or features of Punits 106/606 at CBB dies 102/602 of SOC 101/601.

According to some examples, logic flow 700 at block 702 can couple a volatile memory maintained on a first die of a multi-die SOC with a first power rail. For these examples, the volatile memory can be a volatile memory at the first die and the first die can be iMH die 110 and the volatile memory can be Clog SRAM 115, Clog SRAM 111 or Clog SRAM 117 coupled to Vnn rail 150.

In some examples, logic flow 700 at block 704 can receive an indication of a catastrophic error encountered at one or more dies of the multi-die SOC. For these examples, indication can be received at RASIP 114 at iMH die 110 based on a core at a CBB die triggering a three-strike timeout to trigger the catastrophic error.

According to some examples, logic flow 700 at block 706 can cause error related information to be written to one or more crash log records to be stored in the volatile memory. For these examples, logic and/or features of S3M 112, Ounit 116 and Punit 118 can cause the error related information to be written to the crash log records to be stored in respective Clog SRAMS 111, 115 and 118.

In some examples, logic flow 700 at block 708 can, responsive to a request received following a global reset of the multi-die SOC, provide the error related information written to the one or more crash log records to the requestor, wherein during the global reset of the multi-die SOC the first power rail is to continually maintain power to the volatile memory. For these examples, logic and/or features of S3M 112, Ounit 116 and Punit 118 can provide the error related information to a BIOS 190 or OS 195 following the global reset of SOC 101. Also, during the global reset, Vnn rail 150 can continually maintain power to Clog SRAMS 111, 115 and 118.

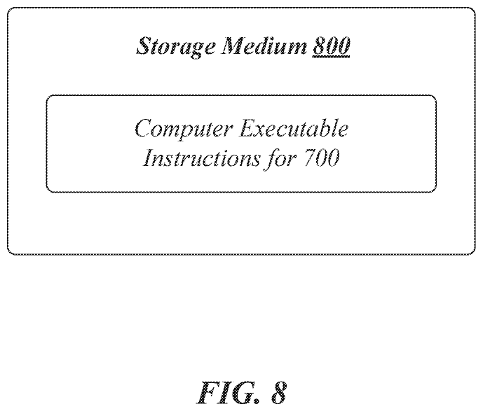

FIG. 8 illustrates an example storage medium 800. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

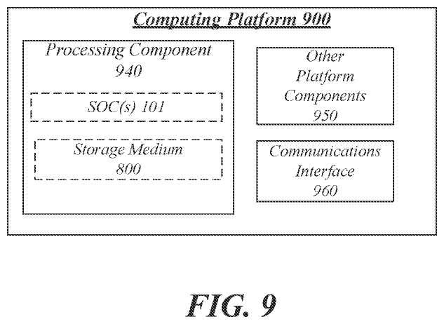

FIG. 9 illustrates an example computing platform 900. In some examples, as shown in FIG. 9, computing platform 900 can include a processing component 940, other platform components 950 or a communications interface 960. According to some examples, computing platform 900 can be capable of coupling to a network and can be part of a datacenter including a plurality of network connected computing platforms.

According to some examples, processing component 940 can include one or more SOCs (e.g., in multiple sockets—not shown) such as SOC(s) 101 and storage medium such as storage medium 800. Processing component 940 can include various hardware elements, software elements, or a combination of both. Examples of hardware elements can be SOC(s) 101 and associated memory units (e.g., memory units associated with multi-level cache hierarchies for SOC(s) 101). Examples of software elements can include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 950 can include co-processors, accelerator, memory units, chipsets, controllers, peripherals, interfaces, oscillators, timing devices, video cards, audio cards, multimedia input/output (I/O) components (e.g., digital displays that can be locally or remotely coupled to computing platform 900), power supplies, and so forth. Examples of memory units can include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that can be byte or block addressable. Non-volatile types of memory can also include other types of byte or block addressable non-volatile memory such as, but not limited to, multi-threshold level NAND flash memory, NOR flash memory, single or multi-level phase change memory, resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above. Other types of computer readable and machine readable storage media can also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 can include logic and/or features to support a communication interface. For these examples, communications interface 960 can include one or more communication interfaces that operate according to various communication protocols or standards to communicate over direct or network communication links or channels. Direct communications can occur via use of communication protocols or standards described in one or more industry standards (including progenies and variants) such as those associated with the PCIe specification or the CXL specification. Network communications can occur via use of communication protocols or standards such those described in one or more Ethernet standards promulgated by IEEE. For example, one such Ethernet standard can include IEEE 802.3. Network communication can also occur according to one or more OpenFlow specifications such as the OpenFlow Hardware Abstraction API Specification.

As mentioned above computing platform 900 can be implemented in a server of a datacenter. Accordingly, functions and/or specific configurations of computing platform 900 described herein, can be included or omitted in various embodiments of computing platform 900, as suitably desired for a server deployed in a datacenter.

The components and features of computing platform 900 can be implemented using any combination of discrete circuitry, ASICs, logic gates and/or single chip architectures. Further, the features of computing platform 900 can be implemented using microcontrollers, programmable logic arrays and/or microprocessors or any combination of the foregoing where suitably appropriate. It is noted that hardware, firmware and/or software elements can be collectively or individually referred to herein as “circuitry”, “logic” or “feature.”

It should be appreciated that the exemplary computing platform 900 shown in the block diagram of FIG. 9 can represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example can be implemented by representative instructions stored on at least one machine-readable medium which represents various logic within the processor, which when read by a machine, computing device or system causes the machine, computing device or system to fabricate logic to perform the techniques described herein. Such representations, known as “IP cores” can be stored on a tangible, machine readable medium and supplied to various customers or manufacturing facilities to load into the fabrication machines that actually make the logic or processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples can include an article of manufacture or at least one computer-readable medium. A computer-readable medium can include a non-transitory storage medium to store logic. In some examples, the non-transitory storage medium can include one or more types of computer-readable storage media capable of storing electronic data, including volatile memory or non-volatile memory, removable or non-removable memory, erasable or non-erasable memory, writeable or re-writeable memory, and so forth. In some examples, the logic can include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium can include a non-transitory storage medium to store or maintain instructions that when executed by a machine, computing device or system, cause the machine, computing device or system to perform methods and/or operations in accordance with the described examples. The instructions can include any suitable type of code, such as source code, compiled code, interpreted code, executable code, static code, dynamic code, and the like. The instructions can be implemented according to a predefined computer language, manner or syntax, for instructing a machine, computing device or system to perform a certain function. The instructions can be implemented using any suitable high-level, low-level, object-oriented, visual, compiled and/or interpreted programming language.

Some examples can be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples can be described using the expression “coupled” and “connected” along with their derivatives. These terms are not necessarily intended as synonyms for each other. For example, descriptions using the terms “connected” and/or “coupled” can indicate that two or more elements are in direct physical or electrical contact with each other. The term “coupled” or “coupled with”, however, can also mean that two or more elements are not in direct contact with each other, but yet still co-operate or interact with each other.

The follow examples pertain to additional examples of technologies disclosed herein.

Example 1. An example apparatus can include a volatile memory maintained on a first die of a multi-die SOC, the volatile memory arranged to couple with a first power rail. The apparatus can also include circuitry on the first die. The circuitry on the first can be configured to receive an indication of a catastrophic error encountered at one or more dies of the multi-die SOC. The circuitry of the first die can also be configured to cause error related information to be written to one or more crash log records to be stored in the volatile memory. The circuitry on the first die can also be configured to, responsive to a request received following a global reset of the multi-die SOC, provide the error related information written to the one or more crash log records to the requestor. For this example, during the global reset of the multi-die SOC, the first power rail can continually maintain power to the volatile memory.

Example 2. The apparatus of example 1, the volatile memory can be static random access memory.

Example 3. The apparatus of example 1, the circuitry on the first die can be further configured to cause a signal to be asserted following receipt of the indication of the catastrophic error to delay the global reset of the SOC for a period of time to enable the error related information to be gathered and written to the one or more crash log records. The circuitry on the first die can also be configured to cause the signal to be de-asserted to end the delay to the global reset following the end of the period of time.

Example 4. The apparatus of example 1, the multi-die SOC can be a processor, the first die can be an integrated memory hub die, and the one or more dies that encountered the catastrophic error can be core building block dies that each include multiple cores.

Example 5. The apparatus of example 4, the catastrophic error can be triggered by a three-strike timeout at one or more cores of the multiple cores included on at least one of the core building block dies.

Example 6. The apparatus of example 1, the multi-die SOC can be a processor and the first die is a first core building block die from among a plurality of core building block dies that each include multiple cores. For this example, the one or more dies that encountered the catastrophic error can be the first core building block die.

Example 7. The apparatus of example 6, the catastrophic error can be triggered by a three-strike timeout at one or more cores of the first core building block die.

Example 8. The apparatus of example 1, the requestor can be a BIOS or an OS.

Example 9. The apparatus of example 1, the multi-die SOC can be configured to be inserted into a first socket of a multi-socket computing system. For this example, first socket can be configured as a boot socket and the circuitry on the first die of the multi-die SOC can be further configured to cause the indication of the catastrophic error to be propagated to a second multi-die SOC inserted in a second socket of the multi-socket computing system. The circuitry of a die of the second multi-die SOC can cause error related information to be written to one or more crash log records to be stored in a second volatile memory maintained at the die of the second multi-die SOC. The second volatile memory arranged to couple with a second power rail that maintains power to the second volatile memory during the global reset of the multi-die SOC that can also include a reset of the second multi-die SOC.

Example 10. An example method can include coupling a volatile memory maintained on a first die of a multi-die SOC with a first power rail. The method can also include receiving an indication of a catastrophic error encountered at one or more dies of the multi-die SOC. The method can also include causing error related information to be written to one or more crash log records to be stored in the volatile memory. The method can also include responsive to a request received following a global reset of the multi-die SOC, providing the error related information written to the one or more crash log records to the requestor. For this example, during the global reset of the multi-die SOC, the first power rail can continually maintain power to the volatile memory.

Example 11. The method of example 10, the volatile memory can be static random access memory.

Example 12. The method of example 10 can also include causing a signal to be asserted following receipt of the indication of the catastrophic error to delay the global reset of the SOC for a period of time to enable the error related information to be gathered and written to the one or more crash log records. The method can also include causing the signal to be de-asserted to end the delay to the global reset following the end of the period of time.

Example 13. The method of example 10, the multi-die SOC can be a processor, the first die can be an integrated memory hub die, and the one or more dies that encountered the catastrophic error can be core building block dies that each include multiple cores.

Example 14. The method of example 13, the catastrophic error can be triggered by a three-strike timeout at one or more cores of the multiple cores included on at least one of the core building block dies.

Example 15. The method of example 10, the multi-die SOC can be a processor and the first die can be a first core building block die from among a plurality of core building block dies that each include multiple cores. For this example, the one or more dies that encountered the catastrophic error can be the first core building block die.

Example 16. The method of example 15, the catastrophic error can be triggered by a three-strike timeout at one or more cores of the first core building block die.

Example 17. The method of example 10, the requestor can be a BIOS or an OS.

Example 18. The method of example 10, the multi-die SOC can be configured to be inserted into a first socket of a multi-socket computing system. The first socket can be configured as a boot socket. The method can also include causing the indication of the catastrophic error to be propagated to a second multi-die SOC inserted in a second socket of the multi-socket computing system. For this example, circuitry of a die of the second multi-die SOC can cause error related information to be written to one or more crash log records to be stored in a second volatile memory maintained at the die of the second multi-die SOC. Also, the second volatile memory arranged to couple with a second power rail that maintains power to the second volatile memory during the global reset of the multi-die SOC can also include a reset of the second multi-die SOC.

Example 19. An example at least one machine readable medium can include a plurality of instructions that in response to being executed by a system can cause the system to carry out a method according to any one of examples 10 to 18.

Example 20. An example apparatus can include means for performing the methods of any one of examples 10 to 18.

Example 21. A processor can include a first die configured to include a plurality of cores, a second die to include a volatile memory arranged to couple with a first power rail and to include circuitry. The circuitry of the second die configured to receive, from circuitry of the first die, an indication of a catastrophic error encountered at the first die. The circuitry of the second die also configured to cause error related information to be written to one or more crash log records to be stored in the volatile memory. The circuitry of the second die can also be configured to, responsive to a request received following a global reset of the processor, provide the error related information written to the one or more crash log records to the requestor. For this example, during the global reset of the processor, the first power rail can continually maintain power to the volatile memory.

Example 22. The processor of example 21, the volatile memory can be static random access memory.

Example 23. The processor of example 21, the circuitry of the second die can be further configured to cause a signal to be asserted following receipt of the indication of the catastrophic error to delay the global reset of the processor for a period of time to enable the error related information to be gathered and written to the one or more crash log records. The circuitry of the second die can also be configured to cause the signal to be de-asserted to end the delay to the global reset following the end of the period of time.

Example 24. The processor of example 21, the catastrophic error can be triggered by a three-strike timeout at one or more cores of the plurality of cores at the first die.

Example 25. The processor of example 24, the first die can be a first core building block die from among a plurality of core building block dies that each include multiple cores. The second die can be a first integrated memory hub die from among a plurality of integrated memory hub dies. For this example, circuitry of the first die can send the indication of the catastrophic error to the circuitry of the second die responsive to the three-strike timeout at the one or more cores of the plurality of cores at the first die.

Example 26. The processor of example 21, the requestor can be a BIOS or an OS.

Example 27. The processor of example 21, the processor can be configured to be inserted into a first socket of a multi-socket computing system. The first socket can be configured as a boot socket. The circuitry of the second die can be further configured to cause the indication of the catastrophic error to be propagated to a second processor inserted in a second socket of the multi-socket computing system. Circuitry of a die of the second processor can cause error related information to be written to one or more crash log records to be stored in a second volatile memory maintained at the die of the second processor. The second volatile memory arranged to couple with a second power rail can maintain power to the second volatile memory during the global reset of the processor can also include a reset of the second processor.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a volatile memory maintained on a first die of a multi-die system-on-a-chip (SOC), the volatile memory arranged to couple with a first power rail; and
circuitry on the first die configured to:
receive an indication of a catastrophic error encountered at one or more dies of the multi-die SOC;
cause error related information to be written to one or more crash log records to be stored in the volatile memory; and
responsive to a request received following a global reset of the multi-die SOC, provide the error related information written to the one or more crash log records to the requestor, wherein during the global reset of the multi-die SOC, the first power rail is to continually maintain power to the volatile memory.

2. The apparatus of claim 1, wherein the volatile memory comprises static random access memory.

3. The apparatus of claim 1, wherein the circuitry on the first die is further configured to:
cause a signal to be asserted following receipt of the indication of the catastrophic error to delay the global reset of the SOC for a period of time to enable the error related information to be gathered and written to the one or more crash log records; and
cause the signal to be de-asserted to end the delay to the global reset following the end of the period of time.

4. The apparatus of claim 1, wherein the multi-die SOC comprises a processor, the first die is an integrated memory hub die and the one or more dies that encountered the catastrophic error are core building block dies that each include multiple cores.

5. The apparatus of claim 4, wherein the catastrophic error was triggered by a three-strike timeout at one or more cores of the multiple cores included on at least one of the core building block dies.

6. The apparatus of claim 1, wherein the multi-die SOC comprises a processor and the first die is a first core building block die from among a plurality of core building block dies that each include multiple cores, and wherein the one or more dies that encountered the catastrophic error is the first core building block die.

7. The apparatus of claim 6, wherein the catastrophic error was triggered by a three-strike timeout at one or more cores of the first core building block die.

8. The apparatus of claim 1, wherein the requestor comprises a basic input/output operating system (BIOS) or an operating system (OS).

9. The apparatus of claim 1, wherein the multi-die SOC is configured to be inserted into a first socket of a multi-socket computing system, and wherein the first socket is configured as a boot socket, and wherein the circuitry on the first die of the multi-die SOC is further configured to:
cause the indication of the catastrophic error to be propagated to a second multi-die SOC inserted in a second socket of the multi-socket computing system, wherein circuitry of a die of the second multi-die SOC is to cause error related information to be written to one or more crash log records to be stored in a second volatile memory maintained at the die of the second multi-die SOC, the second volatile memory arranged to couple with a second power rail that maintains power to the second volatile memory during the global reset of the multi-die SOC that also includes a reset of the second multi-die SOC.

10. A method comprising:
coupling a volatile memory maintained on a first die of a multi-die system-on-a-chip (SOC) with a first power rail;
receiving an indication of a catastrophic error encountered at one or more dies of the multi-die SOC;
causing error related information to be written to one or more crash log records to be stored in the volatile memory; and
responsive to a request received following a global reset of the multi-die SOC, providing the error related information written to the one or more crash log records to the requestor, wherein during the global reset of the multi-die SOC the first power rail is to continually maintain power to the volatile memory.

11. The method of claim 10, further comprising:
causing a signal to be asserted following receipt of the indication of the catastrophic error to delay the global reset of the SOC for a period of time to enable the error related information to be gathered and written to the one or more crash log records; and
causing the signal to be de-asserted to end the delay to the global reset following the end of the period of time.

12. The method of claim 10, wherein the multi-die SOC comprises a processor, the first die is an integrated memory hub die and the one or more dies that encountered the catastrophic error are core building block dies that each include multiple cores.

13. The method of claim 10, wherein the requestor comprises a basic input/output operating system (BIOS) or an operating system (OS).

14. The method of claim 10, wherein the multi-die SOC is configured to be inserted into a first socket of a multi-socket computing system, and wherein the first socket is configured as a boot socket, the method further comprising:
causing the indication of the catastrophic error to be propagated to a second multi-die SOC inserted in a second socket of the multi-socket computing system, wherein circuitry of a die of the second multi-die SOC is to cause error related information to be written to one or more crash log records to be stored in a second volatile memory maintained at the die of the second multi-die SOC, the second volatile memory arranged to couple with a second power rail that maintains power to the second volatile memory during the global reset of the multi-die SOC that also includes a reset of the second multi-die SOC.

15. A processor comprising:
a first die configured to include a plurality of cores; and
a second die to include a volatile memory arranged to couple with a first power rail and to include circuitry, the circuitry configured to:
receive, from circuitry of the first die, an indication of a catastrophic error encountered at the first die;
cause error related information to be written to one or more crash log records to be stored in the volatile memory; and
responsive to a request received following a global reset of the processor, provide the error related information written to the one or more crash log records to the requestor, wherein during the global reset of the processor, the first power rail is to continually maintain power to the volatile memory.

16. The processor of claim 15, wherein the volatile memory comprises static random access memory.

17. The processor of claim 15, wherein the circuitry on the first dies is further configured to:
cause a signal to be asserted following receipt of the indication of the catastrophic error to delay the global reset of the processor for a period of time to enable the error related information to be gathered and written to the one or more crash log records; and
cause the signal to be de-asserted to end the delay to the global reset following the end of the period of time.

18. The processor of claim 15, wherein the catastrophic error was triggered by a three-strike timeout at one or more cores of the plurality of cores at the first die.

19. The processor of claim 18, further comprising:
the first die is a first core building block die from among a plurality of core building block dies that each include multiple cores; and
the second die is a first integrated memory hub die from among a plurality of integrated memory hub dies, wherein the circuitry of the first die is to send the indication of the catastrophic error to the circuitry of the first die responsive to the three-strike timeout at the one or more cores of the plurality of cores at the first die.

20. The processor of claim 15, wherein the processor is configured to be inserted into a first socket of a multi-socket computing system, and wherein the first socket is configured as a boot socket, and wherein the circuitry of the second die is further configured to:
cause the indication of the catastrophic error to be propagated to a second processor inserted in a second socket of the multi-socket computing system, wherein circuitry of a die of the second processor is to cause error related information to be written to one or more crash log records to be stored in a second volatile memory maintained at the die of the second processor, the second volatile memory arranged to couple with a second power rail that maintains power to the second volatile memory during the global reset of the processor that also includes a reset of the second processor.
